(19) United States
(12) Patent Application Publication
(10) Pub. No.: US 2021/0222592 A1
(43) Pub. Date: Jul. 22, 2021

(54) METHOD AND APPARATUS FOR CONVERTING HEAT ENERGY TO MECHANICAL ENERGY

(71) Applicant: 21TDMC Group Oy, Helsinki (FI)

(72) Inventor: Petteri Mikko Samuli PENTTINEN, Jyvaskyla (FI)

(73) Assignee: 21TDMC Group Oy, Berlin-Wilmersdorf (FI)

(21) Appl. No.: 17/257,765

(22) PCT Filed: Jul. 3, 2018
(86) PCT No.: PCT/FI2018/050529

§ 371 Date: Jan. 4, 2021

(51) Int. Cl. F01K 25/02; F01K 27/00

(52) U.S. Cl. CPC F01K 25/02; F01K 27/00

(57) ABSTRACT

An apparatus for converting heat energy to mechanical energy includes a closed circuit having a pressure side with a first conduit, a lower pressure side with a second conduit, two actuators between the pressure sides, a working medium circulated in the closed circuit, a heating source to heat the working medium in the pressure side and a cooling arrangement to cool the working medium in the lower pressure side. The liquid working medium circulated in the closed circuit system is degasified.

The aspects of the disclosed embodiments relate to a method for converting heat energy to mechanical energy, and an apparatus for converting heat energy to mechanical energy.

The method and apparatus, briefly, the solution according to the present disclosure is suited very well for instance to be used in connection with heat engines, motors, etc. One possible use is a power source for a generator to produce electricity. The aspects of the disclosed embodiments are based on a thermal expansion of a working medium in a closed circuit system. Advantageously, the thermal expansion is achieved by the help of an external heat source that is arranged to heat the working medium that is preferably liquid but can also be solid substance. Essential is that the working medium is substantially incompressible or its compression is as minimal as possible.

In prior art various solutions for converting heat energy to mechanical energy are known. In fact, all or almost all existing heat engines are based on the same technology, namely thermal expansion of a gas. A problem with these kinds of heat engines is that in practice the coefficient of efficiency is relatively low, for instance only between 30-40%. Usually at least two thirds of the content of the energy of the fuel used is wasted, mainly as heat.

Some attempts to improve the situation have been made. Thus, different kinds of heat engines based on the thermal expansion of liquids have been created. For instance, U.S. Pat. No. 1,487,664 discloses a solution called The Malone engine. According the US patent the heat engine comprises a sealed cylinder filled with a working medium, for instance mercury or a mercury-lead alloy, in which cylinder the working medium can flow from the first end to the second end. The working medium is heated at the first end of the cylinder where the working medium expands and flows to the second end of the cylinder where the working medium is again cooled. The cylinder contains alternately more hot liquid and alternately more cold liquid, which makes the plunger do work through the alteration of the volume of the liquid in the cylinder.

In independent testing the Malone engine achieved an efficiency of 27%, which exceeded the efficiency of steam engines of those days and approximately equalled the efficiency of gasoline engines, but nowadays that is not sufficient. One disadvantage was a cylinder structure with a reciprocating plunger/displacer mechanism. When moving in the cylinder the plunger/displacer mechanism reveals cylinder wall of different temperatures. In that case temperature transfers to other structure of the engine and thus the engine loses the efficiency.

Another heat engine of prior art using liquid as a working medium is presented in the International patent publication No. WO2011/131373 A1. The publication presents a heat engine that is based on the expansion of a working medium in a closed circulation system. The expansion of the working medium is achieved by an external heating arrangement and the cooling of the working medium is achieved by an external cooling arrangement. Also the heat of the circulation system is used for heating the working medium. The working medium can be either gas, liquid or solid substance. When using liquid as a working medium the incompressibility of the working medium decreases notably if the liquid contains gas. Thus, gas in the liquid working medium, as bubbles or dissolved, leads to a poorer efficiency of the heat engine. However, the WO publication does not mention anything about that important issue.

The object of the present disclosure is to eliminate the drawbacks described above and to achieve a reliable, economical and efficient method and apparatus for converting heat energy to mechanical energy. The method for converting heat energy to mechanical energy according to the disclosed embodiments is characterized by what is presented in the characterization part of claim 1. Correspondingly, the apparatus for converting heat energy to mechanical energy according to the disclosed embodiments is characterized by what is presented in the characterization part of claim 11. Other embodiments of the present disclosure are characterized by what is presented in the other claims.

An aspect of the disclosed embodiments is to provide a method for converting heat energy to mechanical energy, in which method a working medium whose compressibility is smaller than thermal expansion is circulated in a closed circuit system or a closed liquid circuit system comprising a pressure side and a lower pressure side and two actuators between the pressure sides, and in which method the working medium is alternately heated and cooled to produce effective work. Another aspect of the disclosed embodiments is to provide an apparatus for converting heat energy to mechanical energy, which apparatus comprises a closed circuit system having a pressure side with a first conduit, a lower pressure side with a second conduit, two actuators between the pressure sides, a working medium whose compressibility is smaller than thermal expansion circulated in the closed circuit system, and a heating source to heat the working medium in the pressure side and a cooling arrangement to cool the working medium in the lower pressure side. Advantageously, the working medium circulated in the closed circuit system is degasified. In case the working medium is liquid the closed circuit system is preferably vacuumized.

The apparatus according the disclosed embodiments can be a heat engine, motor or another type of apparatus that produces work or shaft power for instance for an external actuator. The function of the apparatus according the present disclosure is based on thermal expansion of a working medium circulated in a closed circuit. An essential feature of the solution of the present disclosure is that the bulk modulus of the working medium used must be smaller than its coefficient of thermal expansion. In that case a heat expands the volume of the working medium more than it can be compressed. Liquid and solid substances fulfill this prerequisite, but gases do not fulfill the prerequisite.

In the solution of the disclosed embodiments the heat brought from an external source heats the working medium in the closed circuit and thus expands the volume of the working medium. In that case the pressure in the closed circuit increases. The increased pressure is directed to an actuator that produces work or shaft power. A part of the obtained shaft power can be used to run the actuator running the working medium and another part of the obtained shaft power can be directed to an external actuator, for example to a generator to produce electricity.

The solution of the disclosed embodiments has significant advantages over the solutions of the prior art. For instance, the coefficient of efficiency is much bigger than with the prior art solutions. Theoretically the coefficient of efficiency can be even between 80-95% also in small temperature differences, whereas the maximum coefficient of efficiency with the prior art heat engines is only 40-50% and the temperature differences must be bigger. Yet one advantage is that the apparatus according to the disclosed embodiments works also in low temperatures and small pressures. Yet one further advantage is that waste heat of industry can be used as an external heat source to heat the working medium circulated in the apparatus according to the disclosed embodiments.

In the following, the disclosed embodiments will be described in detail by the aid of examples by referring to the attached simplified and diagrammatic drawings, wherein

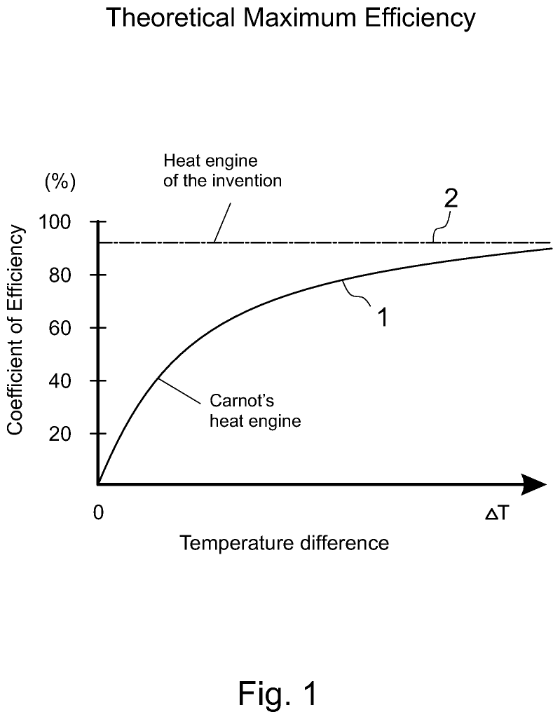

FIG. 1 presents in a chart the coefficient of efficiency of the wellknown Carnot's heat engine and the heat engine according to the disclosed embodiments,

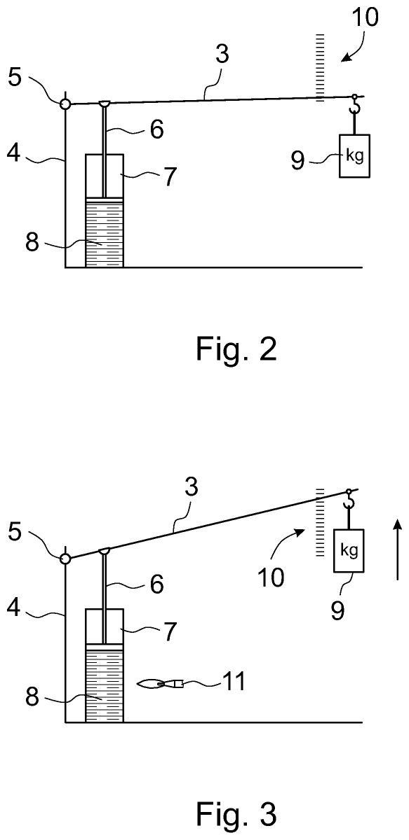

FIG. 2 presents in a side view and in a simplified and diagrammatic way a simple apparatus that demonstrates how work can be done by heating a liquid in a closed space in a situation where the liquid is not heated,

FIG. 3 presents in a side view and in a simplified and diagrammatic way the apparatus according to FIG. 2 in a situation where the liquid is heated,

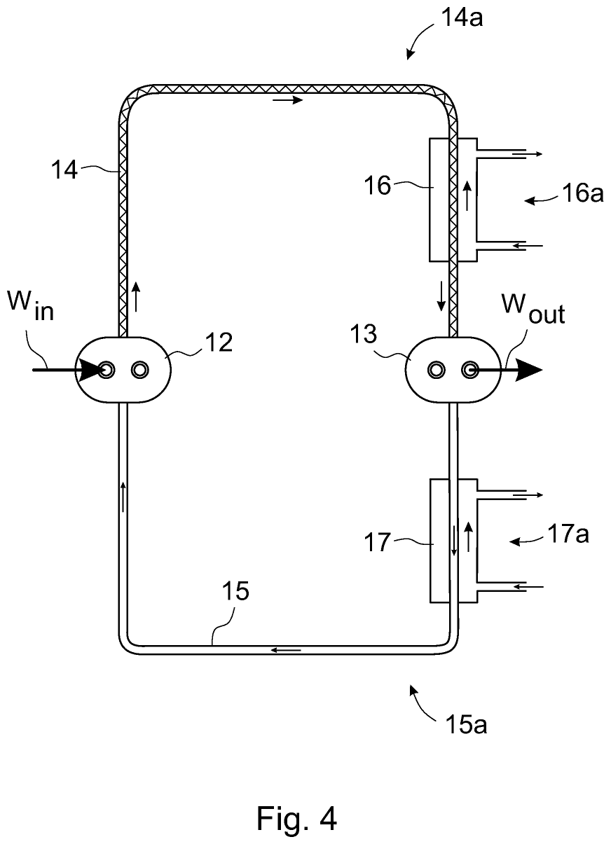

FIG. 4 presents in a simplified and diagrammatic way a principle of the solution of the disclosed embodiments, and

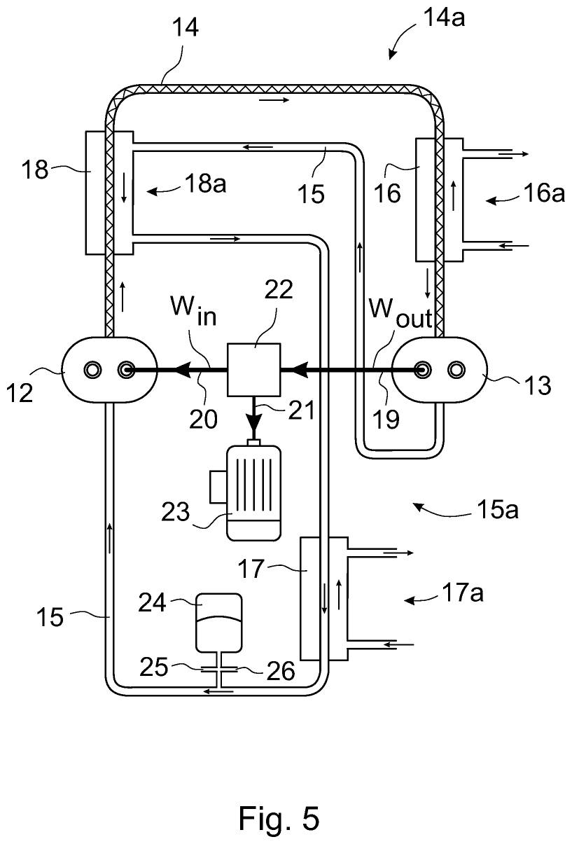

FIG. 5 presents in a simplified and diagrammatic way a principle of an apparatus of the disclosed embodiments producing power to use a generator or another external actuator.

The basic idea of the present disclosure is to achieve a method and apparatus to produce shaft power or work by circulating a working medium whose compressibility is smaller than thermal expansion in a closed circuit system, which working medium is alternatively heated and cooled. When heated the volume of the working medium expands and the pressure in the working medium increases. The increased pressure is used to do the shaft power or work mentioned above. Advantageously the working medium is degasified liquid.

FIG. 1 presents in a chart the curve 1 of the theoretical maximum coefficient of efficiency of the Carnot's heat engine and the curve 2 of the theoretical maximum coefficient of efficiency of the heat engine according to the disclosed embodiments. The Carnot's heat engine is the best known in this field of technology. As can be seen in the chart the coefficient of efficiency of the Carnot's heat engine is dependent on temperature differences. The bigger the difference the bigger the coefficient of efficiency. However, the curve 1 of the Carnot's heat engine is not linear. In lower temperatures the curve 1, and the coefficient of efficiency, increases considerably fast but the bigger the temperature difference the slower the coefficient of efficiency increases.

The Carnot's law is purely based on thermal behavior of gases, likewise all existing commercial heat engines. However, it is possible to create a heat engine that has a better coefficient of efficiency than the Carnot's heat engine has, particularly in low temperatures. That is possible if the gaseous working medium of the Carnot's heat engine is replaced with a liquid or solid working medium.

The curve 2 in FIG. 1 represents the theoretical maximum coefficient of efficiency of the heat engine according to the disclosed embodiments. In this case a liquid working medium is used. The most significant difference in relation to the coefficient of efficiency of the Carnot's heat engine is that now the coefficient of efficiency is not dependent on temperature. The theoretical maximum coefficient of efficiency of the heat engine according to the disclosed embodiments can be achieved regardless of the temperature difference as the curve 2 indicates in FIG. 1. That is possible because the liquids used have inverse values of thermal expansion and compressibility compared to those of gases. In that case, with used liquids the compressibility is smaller than the thermal expansion, whereas with gases the thermal expansion is smaller than the compressibility. Thus, when using a liquid as a working medium, it is possible to achieve a situation where mechanical output work Wₒᵤₜ can be obtained from a system thanks to purely a pressure difference without a temperature change in the actuator that does work, for instance in a pump, motor, turbine or cylinder.

In order to achieve the characteristics and advantages according the disclosed embodiments the following prerequisites must be fulfilled:
no phase transition takes place in the actuator
the working medium used must be liquid or solid
the thermal expansion of the working medium used must be bigger than its compressibility in a selected area of pressure and temperature
the working medium used must be gas free or degasified
the circulation process of the working medium must be fully closed and hermetic.

The coefficient of efficiency of the heat engine according to the disclosed embodiments and the ability to convert heat energy to mechanical energy is advantageously calculated according to the formulas as follows:

Wₒᵤₜ=Qᵢₙ−E_{B}−E_{T} (Formula 1)

η=(Qᵢₙ−E_{B}−E_{T})/Qᵢₙ (Formula 2)

### Where:

Wₒᵤₜ=obtained mechanical work, for example a shaft power
Qᵢₙ=heat energy brought to the working medium
E_{B}=loss of volume depending on the bulk modulus of the working medium
E_{T}=temperature change caused by the bulk modulus when the pressure changes
η=coefficient of efficiency

The formulas can also be used to calculate the output capacity of a heat engine comprising a gaseous working medium. In that case the result is the same as calculated with the Carnot's formula.

Formula 1 gives a maximum theoretical output work Wₒᵤₜ of heat engines having liquid or solid working medium, and Formula 2 gives the maximum heat work efficiency q of heat engines having liquid or solid working medium.

The Formulas 1 and 2 can be called as Samuli's law for liquid and solid heat engines.

In the solution according to the disclosed embodiments the temperature difference over the actuator making mechanical work Wₒᵤₜ for output is in practice almost zero. That is why the mechanical work Wₒᵤₜ obtained as output is based on the pressure difference over the actuator instead of the temperature difference.

FIGS. 2 and 3 present in a side view and in a simplified and diagrammatic way a simple apparatus that demonstrates how work can be done only by heating a liquid 8 in a closed space, for instance in a closed circuit system. In the situation of FIG. 2 the liquid 8 is not heated and in the situation of FIG. 3 the liquid 8 is heated.

The apparatus comprises a frame standing on a base, the frame comprising at least a substantially horizontal lifter arm 3 and a vertical supporting arm 4 that are joined together with a hinge 5 so that the lifter arm 3 can be turned around the hinge 5 in a vertical plane. A cylinder 7 comprising a piston with a piston rod 6 and filled with a liquid 8 is placed on the base so that the piston rests on the surface of the liquid 8 in the cylinder 7. On its upper end the piston rod 6 has been joined with the lifter arm 3 to move the lifter arm 3 in the vertical plane. In the free end of the lifter arm 3 there is a load 9 that draws the lifter arm 3 downwards. And finally, the figures show a scale 10 to measure the movement of the lifter arm 3 in the vertical plane.

In the situation of FIG. 2 the liquid 8 in the cylinder 7 is in its normal temperature and the lifter arm 3 is about in a horizontal position in the lower part of the scale 10. In the situation of FIG. 3 the liquid 8 in the cylinder 7 is heated with a heating element 11 and because of the thermal expansion the volume of the liquid 8 in the cylinder 7 is expanded. For that reason, the piston with its rod 6 has moved upwards and pushed the lifter arm 3 upwards. This simple demonstration proves that the thermal expansion of liquids can do work.

FIG. 4 presents in a simplified and diagrammatic way a principle of a solution according to the disclosed embodiments. The solution comprises a first actuator 12 and a second actuator 13 that are joined together with a first conduit 14 and the second conduit 15. The actuators 12, 13 and the conduits 14, 15 form a closed, gas free and hermetic liquid circuit system filled with a degasified liquid working medium.

The degasification is performed so that all the gas, both dissolved and/or in bubbles, is removed from the liquid working medium so that the usable liquid working medium contains gas less than 5%. Preferably the liquid working medium contains gas less than 2%, advantageously less than 1%. Preferably, also the entire closed liquid circuit system is vacuumized before entering the degasified liquid working medium into the closed liquid circuit system.

Advantageously, the actuators 12, 13 are pumps or hydraulic motors comprising an input arrangement and an output arrangement. Preferably, the input arrangement can comprise an input shaft and the output arrangement can comprise an output shaft. The actuators 12, 13 can be otherwise similar but advantageously the flow rate of the working medium in the second actuator 13 is bigger than in the first actuator 12.

In the direction of the circulation of the working medium the first conduit 14 is led from the first actuator 12 to the second actuator 13, and the second conduit 15 is led from the second actuator 13 back to the first actuator 12 to close the circulation loop or circuit. The solution comprises a heating source 16 that is arranged to heat the working medium in the first conduit 14. Preferably, the heating source 16 is a counter flow heat exchanger, and the heat is brought from an external heat source. Advantageously, waste heat of industry can be used as the external heat source.

In addition, the solution comprises a cooling arrangement 17 that is arranged to cool the working medium in the second conduit 15 between the second actuator 13 and the first actuator 12. Preferably, the cooling arrangement 17 is a cooling heat exchanger, which is arranged to remove heat from the working medium, for example, to ambient air or to water, such as a river, lake or sea.

When input work Wᵢₙ is brought to the input arrangement of the first actuator 12 the first actuator 12 circulates the working medium in the first conduit 14. The working medium is heated in the first conduit 14 with the heating source 16. In other words, heat energy is brought into the working medium. The volume of the working medium expands when the working medium is heated, and thus the expansion of the working medium causes an increasing pressure in the first conduit 14. Therefore, the area of the first conduit 14 is also called a pressure side 14a, whereas the other side of the circulation in the area of the second conduit 15 can be called a lower pressure side 15a. The pressure in the first conduit 14 affects to the second actuator 13 where the flow rate of the working medium is bigger than in the first actuator 12. Thus, the pressure in the first conduit 14 begins to produce power to the output arrangement of the second actuator 13. This power or shaft power is presented as an output work Wₒᵤₜ in FIG. 4. According to the disclosed embodiments the obtained output work Wₒᵤₜ is bigger than the input work Wᵢₙ brought into the first actuator 12.

After the second actuator 13 the circulation of the working medium continues into the lower pressure side 15a in the second conduit 15 where the working medium is led further back to the first actuator 12. The working medium exits from the second actuator 13 substantially as hot as it entered to the second actuator 13 but before entering back to the first actuator 12 the working medium is cooled in the second conduit 15. The cooling phase 17a is made with the cooling arrangement 17. Thus, the temperature of the working medium decreases in the second conduit 15 and at the same time the volume of the working medium decreases, which causes the pressure to drop in the second conduit 15.

The work cycle continues in the closed circuit between the actuators 12, 13 as long as the input work Wᵢₙ is brought into the first actuator 12 and the heating phase 16a and the cooling phase 17a are active. Advantageously, the power for the input work Wᵢₙ is obtained from the part of the output work Wₒᵤₜ of the second actuator 13 as will be explained in connection with FIG. 5.

FIG. 5 presents in a simplified and diagrammatic way a principle of an apparatus according to the disclosed embodiments producing shaft power to use an external actuator 23, advantageously a generator. In this embodiment of the apparatus the work cycle of the working medium with all the relevant components like actuators 12, 13, conduits 14, 15 and heating and cooling phases 16a, 17a is basically the same as in the solution according to FIG. 4 but now the coefficient of efficiency has been improved by an additional heating phase 18a where an additional heat exchanger 18 is arranged to supply additional heat energy to the working medium in the first conduit 14. This heat energy is taken from the waste heat of the working medium after the second actuator 13. Thus, the additional heat energy is taken from the working medium circulation itself and at the same time the working medium in the lower pressure side 15a is cooled for the next work cycle.

The additional heat exchanger 18 is advantageously a counter flow heat exchanger and is arranged to get its heat energy from the working medium in the second conduit 15 after the second actuator 13 and before the cooling arrangement 17.

The apparatus according to FIG. 5 is arranged to do work. For that purpose the output of the second actuator 13 is operatively connected to the input of the first actuator 12 to keep the circulation of the working medium running. The apparatus comprises a torque divider 22 that is advantageously a differential gear that is arranged to share the output power of the output shaft 19 of the second actuator 13 to the first actuator 12 through the primary power shaft 20 and to the generator 23 through a secondary power shaft 21 to produce electric energy. Because the output work Wₒᵤₜ of the actuator 13 is bigger than the input work Wᵢₙ needed for the actuator 12 to maintain the circulation of the working medium a part of the output work Wₒᵤₜ can be directed to run the generator 23.

Preferably, the differential gear 22 has a stepless ratio of division. In that case, the differential gear 22 is arranged to automatically distribute the output power of the second actuator 13 to the first actuator 12 and to the generator 23 depending on the need of power of the actuators 12, 23. Thus, when using the secondary power shaft 21 in the differential gear 22 the power of the first actuator 12 is self-adjusting. In that case the entire apparatus according to the disclosed embodiments is self-adjusting depending on the load. For example, when the generator 23 decelerates because of an increased load the primary power shaft 20 of the differential gear 22 transmits automatically more power from the second actuator 13 to the first actuator 12. In that case the flow of the working medium increases in the conduit 14 of the pressure side 14a, and the second actuator 13 produces more power to share between the first actuator 12 and the generator 23.

The apparatus comprises an expansion tank 24 for balancing the total quantity of the working medium in the closed circuit system. Preferably, the expansion tank 24 is joined to the second conduit 15 and comprises two or more connection assemblies 25, 26 through which a relief valve, air venting, working medium filling and other needed components are connected to the system.

It is obvious to the person skilled in the art that the disclosed embodiments is not restricted to the examples described above but that it may be varied within the scope of the claims presented below. Thus, for example, instead of a liquid substance the working medium can also be a solid substance.

It is also obvious to the person skilled in the art that the torque divider can be another type of divider than a differential gear. It is only preferable that the shaft power of the second actuator can be distributed self-adjustable in a required distribution ratio to the first actuator to run the working medium and to the external actuator.

It is further obvious to the person skilled in the art that one or more heat pumps can be used as an external heat source and/or a cooling element. In that case other external heat sources or cooling elements are not necessarily needed.

1. A method for converting heat energy to mechanical energy, in which method a working medium whose compressibility is smaller than thermal expansion is circulated in a closed circuit system comprising a pressure side and a lower pressure side and two actuators between the pressure sides, and in which method the working medium is alternately heated and cooled to produce effective work, wherein in a work cycle a cooled degasified working medium is led from a first actuator to a first conduit in the pressure side where the working medium is heated and led further to a second actuator from where the heated working medium is led to a second conduit in the lower pressure side where the working medium is cooled and led further back to the first actuator to begin the next work cycle, and that the working medium in the second conduit is used to heat the working medium in the first conduit.

2. The method for converting heat energy to mechanical energy according to claim 1, wherein a liquid that contains gas less than 5% suitably less than 2%, advantageously less than 1% is used as the working medium which is heated in a pressure side of the closed circuit system to produce pressure into the closed circuit system, which pressure is arranged to do effective work, and which working medium is cooled in a lower pressure side of the closed circuit system to reduce the pressure created in the pressure side.

3-4. (canceled)

5. The method for converting heat energy to mechanical energy according to claim 1, wherein the heat energy to heat the working medium in the first conduit is taken from an external heat source.

6. The method for converting heat energy to mechanical energy according to claim 1, wherein the energy to cool the working medium in the second conduit is taken from an external cold source.

7. The method for converting heat energy to mechanical energy according to claim 1, wherein the degasified working medium is circulated in the vacuumized closed circuit system.

8. The method for converting heat energy to mechanical energy according to claim 1, wherein a first part of work output (Wₒᵤₜ) of the second actuator is directed to the first actuator to circulate the working medium, and a second part of the work output (Wₒᵤₜ) of the second actuator is directed to an external actuator.

9. The method for converting heat energy to mechanical energy according to claim 8, wherein the work output (Wₒᵤₜ) of the second actuator is automatically adjusted depending of the load of the external actuator.

10. The method for converting heat energy to mechanical energy according to claim 8, wherein the work output (Wₒᵤₜ) of the second actuator is shared to at least two different actuators through a torque divider, such as a differential gear.

11. An apparatus for converting heat energy to mechanical energy, which apparatus comprises a closed circuit system having a pressure side with a first conduit, a lower pressure side with a second conduit, two actuators between the pressure sides, a working medium whose compressibility is smaller than thermal expansion circulated in the closed circuit system, and a heating source to heat the working medium in the pressure side and a cooling arrangement to cool the working medium in the lower pressure side, wherein the first conduit in the pressure side is arranged to lead a cooled degasified working medium from a first actuator to the heading source for heating the working medium, and after heating further to a second actuator from where the second conduit in the lower pressure side is arranged to lead the heated working medium to the cooling arrangement for cooling the working medium, and after cooling back to the first actuator, and that the apparatus comprises an additional heating phase when an additional heat exchanger is arranged to supply additional heat energy to the working medium in the first conduit.

12. The apparatus for converting heat energy to mechanical energy according to claim 11, wherein the working medium is liquid that contains gas less than 5%.

13. The apparatus for converting heat energy to mechanical energy according to claim 12, wherein the liquid working medium contains gas less than 2%, advantageously less than 1%.

14. The apparatus for converting heat energy to mechanical energy according to claim 11, wherein the closed circuit system is vacuumized.

15-16. (canceled)

17. The apparatus for converting heat energy to mechanical energy according to claim 11, wherein the apparatus comprises a torque divider that is arranged to share a first part of the output power of the second actuator to the first actuator to circulate the working medium, and a second part of the output power of the second actuator to an external actuator.

18. The apparatus for converting heat energy to mechanical energy according to claim 17, wherein the torque divider is a differential gear that is arranged to automatically distribute the output power of the second actuator to the first actuator and to the external actuator in a ration of division that depends on the need of power of each actuator.

19. The apparatus for converting heat energy to mechanical energy according to claim 11, wherein the additional heat exchanger is arranged to get its heat energy from the working medium in the second conduit after the second actuator and before the cooling arrangement.
